(19) United States
(12) Patent Application Publication
(10) Pub. No.: US 2022/0223919 A1
(43) Pub. Date: Jul. 14, 2022

(54) METHOD AND APPARATUS FOR PRODUCING AN ELECTRODE STACK

(71) Applicants: Christina FREIFRAU VON BOESELAGER, Braunschweig (DE); Ruben LEITHOFF, Walsrode (DE); Arian FRÕHLICH, Haste (DE); VOLKSWAGEN AKTIENGESELLSCHAFT, Wolfsburg (DE)

(72) Inventors: Dennis BÖHM, Wolfenbüttel (DE); Alexander BREUER, Celle (DE); Marco JORDAN, Salzgitter (DE); Christina FREIFRAU VON BOESELAGER, Braunschweig (DE); Ruben LEITHOFF, Walsrode (DE); Arian FRÕHLICH, Haste (DE)

(73) Assignees: VOLKSWAGEN AKTIENGESELLSCHAFT, Wolfsburg (DE); Christina FREIFRAU VON BOESELAGER, Braunschweig (DE); Ruben LEITHOFF, Walsrode (DE); Arian FRÕHLICH, Haste (DE)

(21) Appl. No.: 17/603,860

(22) PCT Filed: Apr. 14, 2020
(86) PCT No.: PCT/EP2020/060411

§ 371 Date: Nov. 8, 2021

(30) Foreign Application Priority Data
Apr. 15, 2019 (DE) 10 2019 205 428.5

(51) Int. Cl. H01M 10/0585; H01M 10/0525

(52) U.S. Cl. CPC H01M 10/0585; H01M 2220/20; H01M 10/0525

(57) ABSTRACT

The invention relates to a method for producing an electrode stack made of anodes and cathodes for a lithium-ion battery, in particular of an electrically powered motor vehicle, wherein the anodes or the cathodes are provided with a separator, wherein the anodes and the cathodes are conveyed into receiving areas of a rotationally driven or rotatably driven stacking wheel; wherein the anodes and cathodes received in the receiving areas are conveyed to a stacking compartment by rotation of the stacking wheel; wherein the anodes and the cathodes are held in the region of the stacking compartment by a removal arm and are transferred from the respective receiving areainto the stacking compartment as a result of the rotation of the stacking wheel, wherein said anodes and cathodes are stacked in an alternating manner in the stacking compartment; and wherein the alternately stacked anodes and cathodes are pressed against one another in the stacking compartment. The invention additionally relates to a device for producing such an electrode stack.

The invention relates to a method and to an apparatus for producing an electrode stack made of anodes and cathodes, for a lithium-ion battery.

Such a lithium-ion battery has at least one battery cell in which is accommodated an electrode stack with a number of sheet-like cathodes (cathode sheets, cathode films) and sheet-like anodes (anode sheets, anode films), wherein the cathodes and the anodes are stacked on top of each other, for example, and wherein a separator is arranged between each of the cathodes and the anodes.

The electrode stack with anodes and cathodes stacked on top of each other is produced, for example, by means of so-called single-sheet stacking. Typically, the individual anodes and the cathodes are moved by means of a gripper system (gripping system). A gripper of this gripper system picks up each electrode, i.e. each anode or cathode, conveys it while holding it to a stacking location, and deposits the electrode there. However, such gripper systems are comparatively slow. As a result, the manufacturing process of such an electrode stack is disadvantageously comparatively time-consuming.

The invention is based on the object of specifying a particularly suitable method, and also an apparatus, for producing an electrode stack for a lithium-ion battery. In particular, a production of the electrode stack that is as time-saving as possible can be realized by means of the method and/or by means of the apparatus.

With regard to the method, the stated object is achieved according to the invention by the features of claim 1 and, with regard to the apparatus, by the features of claim 4. Advantageous further developments and designs are the subject matter of the dependent claims. The statements relating to the apparatus also apply analogously to the method, and vice versa.

In the method for producing an electrode stack made of anodes and cathodes for a lithium-ion battery (Li-ion battery), in a first step the anodes and the cathodes are conveyed into receptacles of a stacking wheel which is driven or can be driven in a rotary manner. The receptacles are also referred to as compartments or pockets, and the stacking wheel is also referred to as a conveyor wheel. The stacking wheel preferably rotates at a constant rotational speed.

Expediently, only a single cathode or a single anode is accommodated in each of the receptacles. The cathodes and the anodes are in particular conveyed into the receptacles in such a way that anodes and cathodes are alternately conveyed into the receptacles with respect to a circumferential direction (direction of rotation) of the stacking wheel.

The anodes and the cathodes are collectively referred to as electrodes. These are designed in particular with the shape of a leaf. The electrodes therefore have a comparatively small extension in one spatial direction; in other words, the electrodes are flat. The electrodes are also referred to as electrode sheets, and the anodes and the cathodes as anode sheets and cathode sheets, respectively. The anodes or preferably the cathodes are provided with a separator (a separator film) on both sides, that is to say on their surface sides. In particular, the anodes or the cathodes are laminated with the separator. As a result, a separator is arranged in the electrode stack between the anodes and the cathodes. The anodes and the cathodes expediently each have an electrical contact, also referred to as a tab, which is formed by means of a (cell conductor) current conductor of the given electrode.

Each of the laminated electrodes particularly preferably has the same dimensions with respect to a plane spanned by it as the electrodes not laminated with the separator, with a possible exception in the region of the electrical contact. In other words, the extension of the electrodes provided with the separator film corresponds to the extent of the electrodes not provided with the separator in a plane spanned by the given electrode.

In a second step, the anodes and the cathodes accommodated in the receptacles, that is to say the anodes and the cathodes conveyed into the receptacles, are conveyed to a stacking compartment by means of the rotation of the stacking wheel. As such, the anodes and the cathodes are guided to the stacking compartment by means of the stacking wheel.

In a third step, the anodes and the cathodes are held in the region of the stacking compartment, in particular by means of one or by means of two, preferably fixed, stripper arms. Due to the rotation of the stacking wheel, the anodes and the cathodes are guided out of their respective receptacles and into the stacking compartment. In other words, the anodes and the cathodes are held (supported) against the rotation of the stacking wheel by means of the stripper arm or by means of the stripper arms, such that each receptacle is displaced relative to the assigned electrode due to the rotation of the stacking wheel, and the electrode is accordingly transferred from the given receptacle into the stacking compartment. The anodes and the cathodes are stacked alternately in the stacking compartment. The anodes and the cathodes are preferably introduced into the receptacle of the stacking wheel in such a way that the first electrode transferred from the given receptacle into the stacking compartment is a laminated electrode, in particular a laminated cathode.

In particular, due to the rotation of the stacking wheel, an airflow is generated which supports the transfer of the electrodes from each receptacle into the stacking compartment. In particular, as a result of this, the electrodes are compelled into the stacking compartment.

In a fourth step, the alternately stacked anodes and cathodes are pressed against each other in the stacking compartment to form the electrode stack. The anodes and cathodes pressed against each other are then expediently fixed, in particular wrapped, by means of a separator tape.

Compared to an unguided lowering of the electrodes solely due to gravity, the conveying of the anodes and the cathodes into the stacking compartment by means of the stacking wheel takes place comparatively quickly. Furthermore, a comparatively precise and defined positioning of the electrodes on top of each other is realized by means of the stacking wheel. Furthermore, the anodes and the cathodes are transferred to the stacking compartment by means of the stacking wheel without a gripper, i.e. without the use of a gripper or a gripping device. Because of this, the alternating stacking of the anodes and the cathodes advantageously takes place comparatively quickly, that is to say in a time-saving manner, in particular in comparison to the production of the electrode stack mentioned at the beginning by means of a gripping device. Thus, a process rate of the production of the electrode stack is advantageously increased—in other words, throughput is increased.

According to an advantageous development, in the course of the first step, at least one of the cathodes and at least one of the anodes are simultaneously conveyed into the corresponding receptacles of the stacking wheel. In other words, while one of the anodes is being conveyed into the given receptacle of the stacking wheel, one of the cathodes is also conveyed into the corresponding receptacle. In particular, each conveyor device for conveying the anodes and the cathodes into the receptacles of the stacking wheel has at least one conveyor belt of its own for the anodes and the cathodes.

A period of time which is necessary for the insertion of the anodes and the cathodes into the stacking wheel is advantageously comparatively short and, as a result, the production of the electrode stack is comparatively time-saving.

According to an expedient embodiment of the method, the conveying speed of the anodes and the cathodes into the respective receptacles of the stacking wheel is adjusted in such a way that the anodes and the cathodes, before they are stopped by the stripper arm, are decelerated to a standstill due to friction relative to the respective receptacles. In other words, a relative speed of the anodes and the cathodes for each of the receptacles is then equal to zero. The conveying speed is expediently as high as possible. In this way, the anodes and the cathodes are prevented from hitting the ends of the receptacles in the region of the axis of rotation, and the associated risk of damage to the cathodes or to the anodes is avoided.

The electrode stack produced according to the method is provided in particular for a lithium-ion battery, preferably for a (traction) battery of an electrically driven motor vehicle.

The apparatus is configured and suitable for producing an electrode stack made of anodes and cathodes for a lithium-ion battery, for example for a (traction) battery of an electrically powered motor vehicle. In particular, the electrode stack is produced by means of the apparatus according to any of the variants of the method set out above.

The apparatus has a stacking wheel which can be driven to rotate about an axis of rotation, and which has receptacles for the anodes and for the cathodes which are inserted on the circumference, and the receptacles extending in the axial direction, that is to say in a direction parallel to the axis of rotation. In other words, the stacking wheel has arms (blades) extending outward, that is to say away from the axis of rotation, by means of which the receptacles are formed. The receptacles expediently extend outward against the intended direction of rotation of the stacking wheel. In this way, the receptacles are inclined against a radial direction with respect to the axis of rotation.

According to a first variant of the apparatus, the stacking wheel furthermore has on the circumferential side thereof a recess passage extending in its circumferential direction. The recess therefore spans a plane perpendicular to the axis of rotation. The recess extends through the receptacles. In other words, the recess penetrates (passes through) the receptacles. As such, the arms are not continuous in the axial direction. A stripper arm can be inserted, preferably itself stationary, into the recess as a stop for the anodes and the cathodes accommodated in the receptacles when the stacking wheel rotates, such that, due to the rotation of the stacking wheel, each of the anodes and the cathodes is held so it cannot rotate together with the stacking wheel, and is transferred from the given receptacle into a stacking compartment. The recess is suitably designed in such a way that a distance between the stripper arm and the axis of rotation is less than the end of the receptacles closest to the axis of rotation.

In summary, the stripper arm protrudes into a recess of the stacking wheel that is continuous in the circumferential direction, and is therefore at least partially arranged in the recess. The recess therefore spans a plane perpendicular to the axis of rotation. With respect to the receptacle, the stripper arm consequently moves through the receptacle in the course of the rotation of the stacking wheel. The stripper arm serves as a stop or as a support for the anodes and/or the cathodes entrained by the rotation of the stacking wheel.

According to a second variant of the apparatus, it has two stripper arms, one of which is arranged in front of, and the other of which is arranged behind, the stacking wheel with respect to the axial direction. In other words, the two stripper arms flank the stacking wheel on both sides with respect to the axial direction. The stacking wheel in this case has a smaller extension in the axial direction than the anodes and the cathodes being conveyed or to be conveyed by means of the same. As such, the conveyed anodes and cathodes protrude in the axial direction from the receptacles beyond the stacking wheel, such that the stripper arms form a stop for the anodes and the cathodes accommodated in the receptacles when the stacking wheel rotates. As a result, the anodes and the cathodes are transferred from the respective receptacles into the stacking compartments due to the rotation of the stacking wheel,

In both variants of the apparatus, the anodes and the cathodes are restacked, in alignment with each other, in the stacking compartment in the course of their transfer from the respective receptacles, in particular by means of the stripper arm acting as a stop or by means of the stripper arms acting as stops. The stacking compartment expediently also has a slide. This enables the anodes and the cathodes to be aligned with each other with improved accuracy. The anodes and the cathodes are preferably aligned with one another along their entire circumference, with the exception of the electrical contacts. For this purpose, the slide can be moved toward a wall of the stacking compartment opposite it, or toward the stripper arm. Furthermore, the stacking compartment has a compression unit for generating a pressing force, in particular oriented perpendicular to a bottom of the stacking compartment, on the anodes and the cathodes stacked in the stacking compartment and aligned with each other.

Furthermore, the apparatus has a conveying device for conveying the anodes and the cathodes into the receptacles of the stacking wheel.

In the first variant of the apparatus, the receptacles suitably each have a wall at the end, with respect to a direction parallel to the axis of rotation—that is to say, a lateral wall. This prevents an undefined displacement of the anodes and/or the cathodes in one direction along the axis of rotation. The direction along the axis of rotation is also referred to here and below as the axial direction.

According to an advantageous embodiment of both variants of the apparatus, the receptacles are arc-shaped, preferably spiral-shaped, in a plane perpendicular to the axis of rotation. As such, the receptacles in this plane have a spiral or arcuate cross-section. In this case, a curvature of the arcuate receptacle increases from the circumferential side toward the axis of rotation—that is to say, it becomes greater as the radial distance from the axis of rotation becomes smaller. Because of this, a frictional force between the receptacles and the anodes and the cathodes conveyed into them increases from the circumferential side to the axis of rotation, that is to say inward, such that the anodes and the cathodes are increasingly decelerated. Thus, the anodes and the cathodes are reliably decelerated to a standstill relative to the receptacle in a timely manner before the anodes and the cathodes are stopped by the stripper arm or by the stripper arms.

According to an advantageous embodiment of the apparatus, the conveying device has at least one first conveyor belt for conveying the cathodes into the corresponding receptacles, and at least one further first conveyor belt for conveying the anodes into the corresponding receptacles. As already shown in the context of the method, it is thus possible to convey at least one of the cathodes and at least one of the cathodes into the corresponding receptacles of the stacking wheel at the same time. In addition, it is not necessary to bring the anodes and the cathodes together in a preceding assembly step when using only one single first conveyor belt.

At correspondingly high conveying speeds of the anodes and the cathodes by means of the first conveyor belt, the anodes and the cathodes can be lifted by the ambient air, such that the anodes and the cathodes are undesirably lifted off the conveyor belt and move in an uncontrolled manner. To avoid this, a second conveyor belt oriented in parallel is provided for each of the first conveyor belts, according to an expedient embodiment of the apparatus. The second conveyor belts each have opposite directions of rotation to the assigned first conveyor belt. The anodes and cathodes are clamped between the corresponding first conveyor belt and the corresponding second conveyor belt. The anodes and cathodes are therefore held in a direction perpendicular to the conveyor belt surfaces of each of the associated first and second conveyor belts. This prevents uncontrolled movement of the anodes and the cathodes during their conveyance into the receptacles of the stacking wheel.

According to an advantageous development of the apparatus, the first conveyor belts and/or the second conveyor belts project into the recess of the stacking wheel or, in the case of the second variant of the apparatus, into a circumferentially arranged and continuous recess of the stacking wheel in its circumferential direction, such that the anodes and the cathodes are conveyed tangentially into the receptacle. In other words, the ends of the first and/or the second conveyor belts, with respect to the conveying direction of the anodes and/or the cathodes, are arranged inside the recess of the stacking wheel. The first and/or the second conveyor belts are thus arranged between the blades of the stacking wheel with respect to the axial direction. In this way, the electrodes are guided for a comparatively long time by means of the conveyor belts, and/or a comparatively high conveying speed of the electrodes into the corresponding receptacles is made possible, and, as a result, a time-saving production of the electrode stack is made possible. The first and second conveyor belts expediently have a smaller extension than the anodes and the cathodes in a direction which is perpendicular to the conveying direction and in the planes spanned by the conveyor belt surfaces of the conveyor belts, or by the anodes and the cathodes. In other words, the electrodes protrude beyond the conveyor belts in the transverse direction of the conveyor belt.

According to a suitable embodiment of the apparatus, the stacking compartment used for removing the electrode stack, in particular together with the compression unit, can be moved away from the stacking wheel and/or tilted about a tilting axis parallel to the axis of rotation.

According to a suitable embodiment, the slide and/or the stripper arm of the apparatus according to the first variant has a (contacting) recess to electrically contact the anodes and the cathodes. Depending on the intended configuration of the electrode stack, the electrical contacts of the anodes and the cathodes are arranged on a common side of the electrode stack or, alternatively, on opposite sides of the electrode stack. Oriented accordingly, the anodes and the cathodes are conveyed into the receptacles of the stacking wheel. If the electrical contacts of the anodes and the cathodes are to be arranged on a common side of the electrode stack, the electrical contacts of the anodes and the cathodes are arranged in each case at the front or rear with respect to their conveying direction in the given receptacle of the stacking wheel. In particular, the slide or the stripper arm then has the contacting receptacle. If the anodes and the cathodes are to be arranged on opposite sides of the electrode stack, the electrical contacts of the anodes are arranged at the front with regard to their conveying direction in the given receptacle of the stacking wheel, and the electrical contacts for the cathodes are arranged at the rear with regard to their conveying direction, or vice versa. In this case, both the slide and the stripper each have a recess for the electrical contacts.

Due to the contacting recesses, damage to the electrical contacts when the anodes and the cathodes are oriented in alignment with each other, or during the process of transferring the anodes and the cathodes from the receptacle, is advantageously avoided, or the risk of this is at least reduced.

Embodiments of the invention are explained in more detail below with reference to the drawings, wherein:

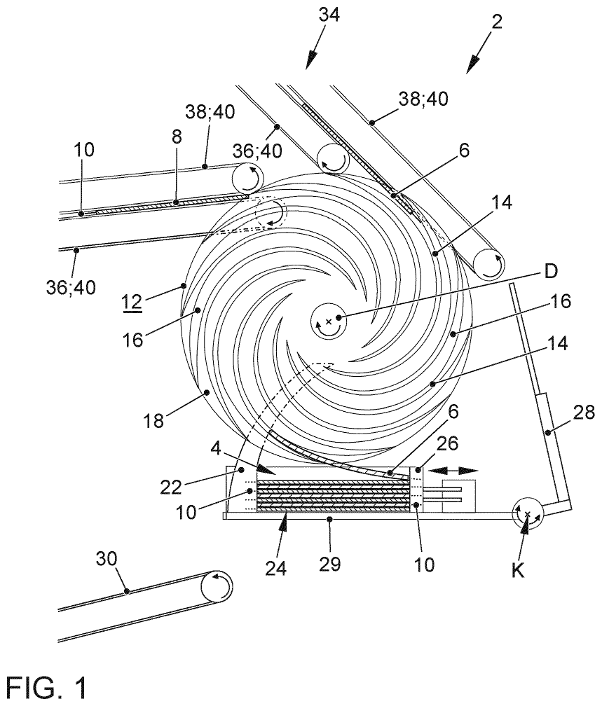

FIG. 1 schematically shows a first variant of an apparatus for producing an electrode stack, having a stacking wheel that can be driven to rotate about an axis of rotation, with receptacles for the anodes and the cathodes, wherein a stripper arm is inserted into a circumferentially continuous recess of the stacking wheel, and by means of this the anodes and the cathodes can be transferred from the receptacles into a stacking compartment,

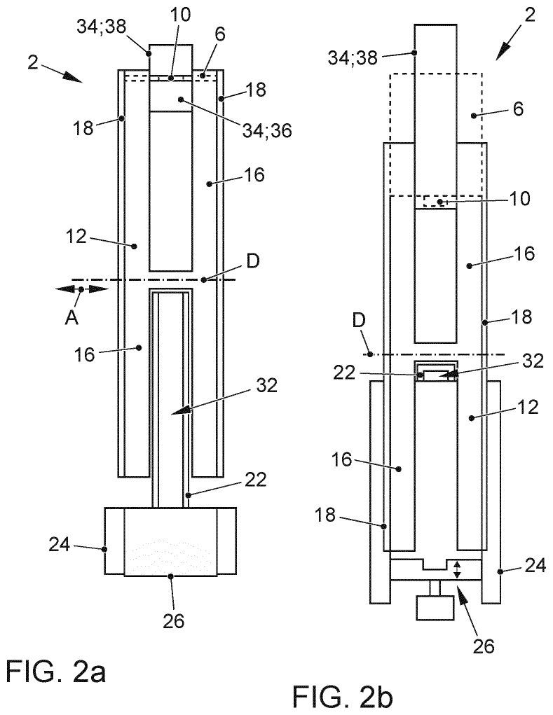

FIG. 2a schematically shows the first variant of the apparatus in a side view, viewed perpendicular to the axis of rotation,

FIG. 2b schematically shows the first variant of the apparatus in a plan view,

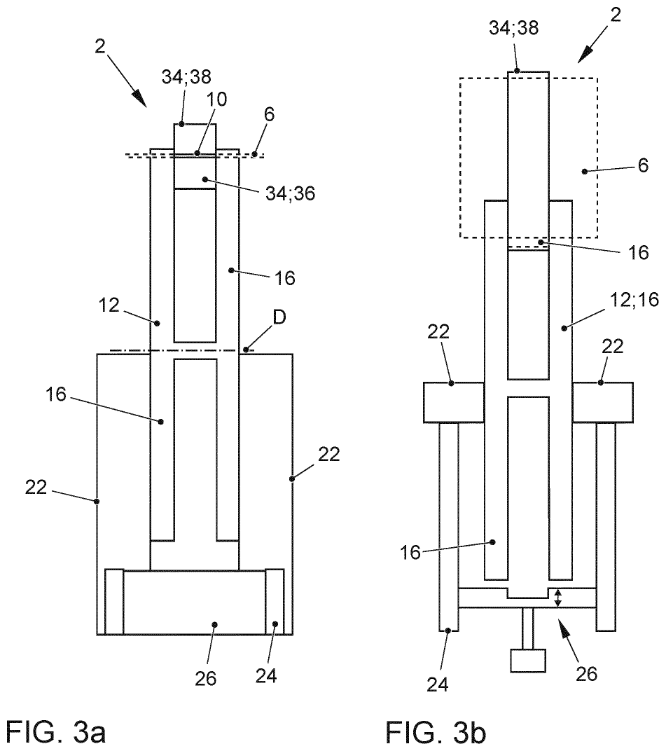

FIG. 3a shows a second variant of the apparatus in a side view, viewed perpendicular to the axis of rotation of its rotationally driven stacking wheel, wherein a stripper arm is arranged in front of the stacking wheel, and another stripper arm is arranged behind the stacking wheel with respect to a direction parallel to the axis of rotation, and these serve as a stop for the anodes and the cathodes conveyed by means of the receptacles of the stacking wheel,

FIG. 3b schematically shows the second variant of the apparatus in a plan view, and

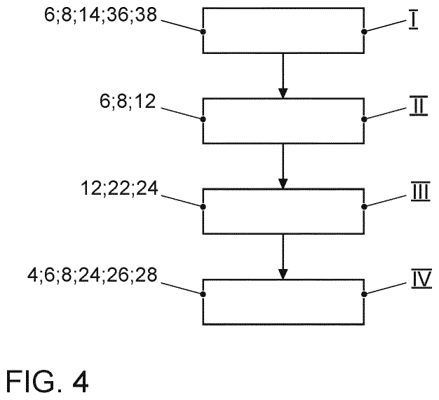

FIG. 4 shows a method sequence for producing the electrode stack, in a flowchart.

Corresponding parts and dimensions are always provided with the same reference signs in all figures.

In FIG. 1 and FIGS. 2a and 2s, a first variant of an apparatus 2 is shown, which is used to produce an electrode stack 4 made of anodes 6 and cathodes 8.

The anodes 6 and the cathodes 8 are sheet-shaped, the cathodes 8 being laminated with a separator which, for the sake of improved clarity, is not shown further in FIGS. 1 to 3b. Furthermore, the anodes 6 and the laminated cathodes 8 each have an electrical contact 10, the same also being referred to as a tab. The anodes 6 each have the same extension with respect to a plane spanned by them as each of the laminated cathodes 8 in a plane spanned by the same, optionally with the exception of their electrical contacts 10.

The electrode stack 4 is intended for a lithium-ion battery (not shown in further detail), for example for a (traction) battery of an electrically powered motor vehicle. The apparatus 2 has a stacking wheel 12 which can be driven to rotate about an axis of rotation D.

The stacking wheel 12 has receptacles 14 for the anodes 6 and for the cathodes 8 formed on the circumference thereof and extending in the axial direction A, that is to say along the axis of rotation D. The receptacles 14 are formed by means of arms 16, which are also referred to as blades, which extend from the region of the axis of rotation D to the circumferential side of the stacking wheel 12—that is to say, outward. The arms 16, and thus also the receptacles 14, are designed in a spiral shape in a plane perpendicular to the axis of rotation D. The receptacles 14 therefore have a spiral cross-section in this plane. In this case, a curvature of the arcuate receptacle increases from the circumferential side toward the axis of rotation D—that is to say, as the radial distance from the axis of rotation D becomes smaller. Furthermore, the receptacles 14 extend outward opposite the direction of rotation of the stacking wheel 12 represented by a corresponding arrow about the axis of rotation D.

The stacking wheel 12 has a wall 18 at each end with respect to the axial direction A, which wall delimits the receptacles 14. In this case, the front wall 18 in the viewing direction is not shown in FIG. 1 for the purpose of visibility. The wall 18 prevents an undefined displacement of the anodes 6 and the cathodes 8 in a direction along the axis of rotation D during the rotation of the stacking wheel 12, and during the process of the anodes 6 and the cathodes 8 being received in the receptacles 14.

As can be seen in particular in FIGS. 2a and 2b, the stacking wheel 12 has a circumferential recess 20 which is continuous in the circumferential direction of the stacking wheel 12. The recess 20 thus extends in a plane perpendicular to the axis of rotation D. The recess 20 also has an extension opposite the radial direction R to the axis of rotation D, which is greater than the extension of the receptacles 14 in this direction. The arms 16 are therefore not continuous in the axial direction A.

A stripper arm 22 is arranged in the recess 20. The section of the stripper arm 22 which is arranged within the recess 20 is shown with dashed lines in FIG. 1. The stripper arm 22 serves as a stop for the anodes 6 and the cathodes 8 accommodated in the receptacles 14. Upon the rotation of the stacking wheel 12, the anodes 6 and the cathodes 8 arranged in the receptacles 14 are displaced relative to the stripper arm 22, such that they are held against further conveyance by means of the stacking wheel 12. Due to the further rotation of the stacking wheel 12, each of the anodes 6 and the cathodes 8 are transferred from the respective receptacles 14 into a stacking compartment 24 arranged in the region of the stripper arm 22.

The stacking compartment 24 has a slide 26 for orienting the anodes 6 and the cathodes 8 in alignment with each other. For this purpose, it is able to move in the direction of the stripper arm 22. This movement is shown in FIG. 1 by means of a double arrow. Furthermore, the stacking compartment 24 has a compression unit 28 for generating a pressing force on the anodes 6 and the cathodes 8 stacked in the stacking compartment 24 and aligned with each other. For this purpose, the compression unit 28 can be pivoted through the recess 20. The electrode stack 4 is formed by orienting the electrodes 6 and 8 in alignment with each other and pressing them together.

According to a variant of the stacking compartment 24, not shown, the compression unit 28 is adjustable in the axial direction A, such that the compression unit 28 cannot be pivoted through the recess 20, but can be moved between the stacking wheel 12 and a bottom 29 of the stacking compartment 24.

The stacking compartment 24 can also be tilted, together with the compression unit 28 and with the stripper arm 22, about a tilting axis K oriented parallel to the axis of rotation D, such that the electrode stack 4 can be removed from the stacking compartment and transported away by means of a conveyor belt 30. By means of the conveyor belt 30, the electrode stack 4, that is to say the electrodes 6 and 8 pressed against each other, can be transported for further production of the battery, or to a magazine or a storage.

In FIG. 1, the apparatus 2 is shown, with a viewing direction along the axis of rotation D; and in FIGS. 2a and 2b, it is shown with a viewing direction perpendicular to the axis of rotation D and parallel or perpendicular to the bottom 29 of the stacking compartment 24. The stripper arm 22 is shown in simplified form in FIGS. 2a and 2b for the purpose of improved clarity.

As can be seen in particular in FIG. 2b, the slide 26 and the stripper arm 22 each have a contacting recess 32 for the electrical contacts 10 of the anodes 6 and the cathodes 8.

Furthermore, the apparatus 2 has a conveying device 34 for conveying the anodes 6 and the cathodes 8 into the receptacles 14 of the stacking wheel 12. The conveyor 34 has two first conveyor belts 36, wherein one of the first conveyor belts 36 only conveys the anodes 6 into the receptacle 14 of the stacking wheel 12, and the other of the first conveyor belts 36 conveys the cathodes into the receptacles 14 of the stacking wheel 12. Furthermore, each of the first conveyor belts 36 is assigned a second conveyor belt 38, wherein each conveyor belt 38 is arranged parallel to the first conveyor belt 36 it is assigned to. Each of the conveyor belt surfaces 40 of the second conveyor belts 38 has an opposite direction of rotation to the conveyor belt surface 40 of the assigned first conveyor belt 36. The first conveyor belts 36 and the assigned second conveyor belts 38 are each spaced apart from each other in such a way that the anodes 6 and the cathodes 8 are clamped between the first conveyor belt 36 and the corresponding second conveyor belt 38 when they are conveyed.

The first conveyor belts 36 protrude partially into the recess 20 of the stacking wheel 12, such that the anodes 6 and the cathodes 8 are conveyed tangentially into the receptacle 14. Those portions of the conveyor belts 36 and 38 which protrude into the recess 20 are shown in dashed lines.

As can be seen in particular in FIG. 2a, the first conveyor belts 36 and the second conveyor belts 38 have a smaller extension than the anodes 6 and the cathodes 8 in a direction which runs perpendicular to the conveying direction and in the planes spanned by their conveyor belt surfaces 40. In other words, the electrodes 6 and 8 protrude beyond the two conveyor belts 38 in the transverse direction of the conveyor belt.

A second variant of the apparatus 2 is shown in FIGS. 3a and 3b. With the exception of what is discussed below, the explanations given above apply analogously to the second variant, and are not shown in further detail here.

The apparatus 2 has two stripper arms 22 which are arranged in the axial direction A on both sides of the stacking wheel 12. In other words, one of the two stripper arms is arranged with respect to the axial direction A in front of the stacking wheel 12, and the other stripper arm 22 is arranged behind it. The stacking wheel 12 in this case has a smaller extension in the axial direction A, such that the anodes 6 and the cathodes 8 accommodated in the receptacles 14 protrude in the axial direction A on both sides beyond the stacking wheel 12. When the stacking wheel 12 rotates, the two stripper arms 22 form a stop for the anodes 6 and the cathodes 8 accommodated in the receptacles 14. The anodes 6 and cathodes 8 are consequently supported against further conveyance due to the rotation of the stacking wheel 12, and are transferred from the given receptacle 14 into the stacking compartment 24.

In comparison to the first variant, the stacking wheel 12 does not have a wall 18 which closes off the receptacles 14 at the ends with respect to the axial direction A.

The stripper arms 22 still have no contacting recess 32 for the electrical contacts 10 of the anodes or the cathodes. Rather, the electrical contacts 10 are arranged between the arms 16 of the stacking wheel.

The flow diagram shown in FIG. 4 illustrates a method for producing an electrode stack 4 from the anodes 6 and the cathodes 8. An apparatus 2 according to FIGS. 1 and 2 is preferably used for this purpose.

In a first step I, the anodes 6 and the cathodes 8 are conveyed into the receptacles 14 of the stacking wheel 12, which is driven to rotate—in particular continuously. In this case, at least one of the anodes 6 and at least one of the cathodes 8 are simultaneously conveyed into the given receptacle 14 of the stacking wheel 12. For this purpose, the apparatus 2, as explained above, has a first conveyor belt for the anodes 6 and a further first conveyor belt 36 for the cathodes 8.

In this case, only a single cathode 8 or a single anode 6 is received in each of the receptacles 14, the anodes 6 and the cathodes 8 being introduced alternately into the receptacles 14 which follow one another with respect to the circumferential direction (direction of rotation) of the stacking wheel 12.

The electrical contacts 10 of the anodes 6 are arranged at the front with respect to their conveying direction into the given receptacle 14 of the stacking wheel 12, and the electrical contacts 10 of the cathodes are arranged at the rear with respect to their conveying direction. In this way, the electrical contacts 10 of the anodes 6 and the cathodes 8 are arranged on opposite sides of the electrode stack 4.

In a second step II, the anodes 6 and the cathodes 8 accommodated in the receptacles 14 are conveyed to a stacking compartment 24 by means of a rotation of the stacking wheel 12.

In a third step III of the method, the anodes 6 and the cathodes 8 are held in the region of the stacking compartment 24 by means of the stripper arm 22 or by means of the stripper arms 22. As such, the anodes 6 and the cathodes 8 are held (supported) against the rotation of the stacking wheel 12 by means of the stripper arm 22 or by means of the stripper arms 22, such that the given receptacle 14 is displaced relative to the associated electrode 6 and/or 8 due to the rotation of the stacking wheel 12, and the electrode 6 and/or 8 is accordingly transferred out of the given receptacle 14 into the stacking compartment 24. The anodes 6 and the cathodes 8 are alternately stacked one on top of the other in the stacking compartment 24.

In addition, the first electrode transferred from each receptacle 14 into the stacking compartment 24 is a laminated cathode 8.

Furthermore, the conveying speed of the anodes 6 and the cathodes 8 into each of the receptacles 14 of the stacking wheel 12 is adjusted in such a way that the anodes 6 and the cathodes 8, before they are stopped by the stripper arm 22 or the stripper arms 22, are decelerated to a standstill relative to the given receptacle, due to friction between the anodes 6 and the cathodes 8 and the given receptacle 14. The conveying speed is adjusted as a function of the shape of the receptacles 14. Due to the spiral shape of the receptacles 14, a frictional force between each receptacle 14 and the electrode 6 or 8 becomes greater toward the end (at the axis of rotation) of the receptacle 14 facing the axis of rotation D.

In a fourth step IV, the alternately stacked anodes 6 and cathodes 8 in the stacking compartment 24 are aligned with each other by means of the slide 26, and are pressed against each other by means of the compression unit 28, forming the electrode stack 4. For this purpose, the compression unit 28 acts with a pressing force on the anodes 6 and the cathodes 8 stacked in the stacking compartment 24 and aligned with each other.

The invention is not limited to the embodiment described above. Rather, other variants of the invention can also be derived therefrom by a person skilled in the art without departing from the subject matter of the invention. In particular, all of the individual features described in connection with the embodiments can also be combined with each other in other ways without departing from the subject matter of the invention.

### LIST OF REFERENCE SIGNS

2 apparatus
4 electrode stack
6 anode
8 cathode
10 electrical contact of the electrode
12 stacking wheel
14 receptacle
16 arm
18 wall
20 recess
22 stripper arm
24 stacking compartment
26 slide
28 compression unit
29 bottom of the stacking compartment
30 conveyor belt
32 contacting recess
34 conveying direction
36 first conveyor belt
38 second conveyor belt
40 conveyor belt surface
I. Conveying the cathodes and the anodes into the receptacles of the stacking wheel
II Conveying the cathodes and the anodes to the stacking compartment by means of the stacking wheel
III Transferring the cathodes and the anodes from the receptacle into the stacking compartment
IV Aligning and pressing the cathodes and the anodes against each other
A axial direction
D axis of rotation
K tilting axis

1. A method for producing an electrode stack from anodes and cathodes for a lithium-ion battery, in particular for an electrically powered motor vehicle, wherein the anodes or the cathodes are provided with a separator, comprising:
conveying the anodes and the cathodes into receptacles of a rotationally driven or rotationally drivable stacking wheel,
conveying the anodes and the cathodes accommodated in the receptacles are conveyed to a stacking compartment by means of a rotation of the stacking wheel,
holding the anodes and the cathodes by means of a stripper arm in the region of the stacking compartment, and transferring the anodes and cathodes due to the rotation of the stacking wheel from the respective receptacles into the stacking compartment, wherein the anodes and the cathodes are stacked alternately in the stacking compartment, and
pressing the alternately stacked anodes and cathodes against each other in the stacking compartment.

2. The method according to claim 1, wherein at least one of the anodes and at least one of the cathodes are conveyed simultaneously into the corresponding receptacles of the stacking wheel.

3. The method according to claim 1, wherein a speed at which the anodes and the cathodes are conveyed into the respective receptacles of the stacking wheel is adjusted in such a way that the anodes and the cathodes, before they are stopped by the stripper arm, are decelerated to a standstill due to friction relative to the given receptacle.

4. An apparatus for producing an electrode stack of anodes and cathodes, for a lithium-ion battery, comprising
a stacking wheel which can be driven to rotate about an axis of rotation, with receptacles for the anodes and the cathodes which are formed on the circumference and which extend in an axial direction,
a conveying device for conveying the anodes and the cathodes into the receptacles of the stacking wheel,
a stripper arm which can be inserted into a recess that is continuous in the circumferential direction of the stacking wheel, and which forms a stop for the anodes and the cathodes accommodated in the receptacles when the stacking wheel rotates, such that the anodes and the cathodes are transferred from the respective receptacles into a stacking compartment due to the rotation of the stacking wheel, or
two stripper arms which are arranged in the axial direction on both sides of the stacking wheel, wherein the stacking wheel has a smaller extension in the axial direction than the anodes and the cathodes, such that the stripper arms form a stop for the anodes and the cathodes accommodated in the receptacles and protruding in the axial direction from the receptacles when the stacking wheel rotates, and wherein the anodes and the cathodes are transferred from the respective receptacles into a stacking compartment due to the rotation of the stacking wheel, and
wherein the stacking compartment has a compression unit for generating a pressing force on the anodes and cathodes stacked in the stacking compartment and/or on the monocells stacked in the stacking compartment.

5. The apparatus according to claim 4, wherein the receptacles are arcuate in a plane perpendicular to the axis of rotation.

6. The apparatus according to claim 5, wherein each conveying device for conveying the anodes into the receptacles of the stacking wheel and for conveying the cathodes into the receptacles has at least one first conveyor belt.

7. The apparatus according to claim 6, wherein each of the first conveyor belts is assigned a second conveyor belt oriented in parallel, with a direction of rotation opposite to the assigned first conveyor belt, such that the anodes and/or the cathodes are clamped during their conveying process between the first conveyor belt and the second conveyor belt.

8. The apparatus according to claim 7, wherein the first conveyor belts and/or the second conveyor belts protrude into the or a recess of the stacking wheel, such that the anodes and the cathodes are conveyed tangentially into the receptacle.

9. The apparatus according to claim 4, wherein, for removing the electrode stack, the stacking compartment together with the compression unit, can be moved and/or tilted about a tilting axis parallel to the axis of rotation.

10. The apparatus according to claim 4, wherein each of the slides of the stacking compartment, and/or the stripper arm, provided for orienting the anodes and the cathodes in alignment with each other, has a contacting recess for electrical contacts of the anodes and the cathodes.
